(19) United States
(12) Patent Application Publication
(10) Pub. No.: US 2014/0310199 A1
(43) Pub. Date: Oct. 16, 2014

(54) SYSTEM AND METHOD FOR HEDGING INDEX EXPOSURES

(71) Applicant: ARES CAPITAL MANAGEMENT PTY LIMITED, Sydney NSW (AU)

(72) Inventors: Matthew Bryce Hardman, Bronte NSW (AU); Benjamin Everard Skilbeck, Bondi NSW (AU)

(21) Appl. No.: 13/929,074

(22) Filed: Jun. 27, 2013

(30) Foreign Application Priority Data
Apr. 11, 2013 (AU) 2013203722

(51) Int. Cl. G06Q 40/00

(52) U.S. Cl. CPC G06Q 40/06
USPC 705/36 R

(57) ABSTRACT

The present invention discloses an engineering solution to the automation of funding assessing and managing collateral dependent loans and indexed linked products. Equity Finance Mortgages (EFM's) are issued by financial institutions and have a return, either profit or loss, which is determined by the way residential real estate market rise or fall respectively. Financial index products sold by some financial entities are akin to bonds or term deposits and pay a return to investors which is linked to the performance of a house or home price index. Consequently, an EFM issuing institution can hedge its exposures to the residential real estate market by selling such financial index products so that profits or losses on the EFM's are offset by the losses or profits respectively of the index products. Methods of calculating an appropriate matching of the dollar value of the EFM's and index products are disclosed. Also disclosed is a vector or distance technique to determine if new EFM's having various characteristics should be added to the existing portfolio of EFM's

### BACKGROUND OF THE INVENTION

This patent specification contains material which is subject to copyright protection. The copyright owner has no objection to the reproduction of this patent specification or related materials from associated patent office files for the purposes of review, but otherwise reserves all copyright whatsoever.

The invention relates to solving the electrical engineering problems associated with an automated method of funding, assessing and managing collateral dependent loans in index linked products. The invention also relates to a computer program product including a computer readable medium having recorded thereon a computer program for solving such problems.

International PCT Patent Publication No. WO2008/104018 to the present applicant discloses methods relating to the development of advanced house price indices that can relatively accurately measure movements in the value of residential property assets over time. Understanding changes in the value of residential housing is important given that residential housing is typically the single largest source of household wealth. The heterogeneity of individual housing assets makes the precise measurement of changes in house prices an exceptionally complex scientific and engineering exercise.

International PCT Patent Publication No. WO2009/094694 to the present applicant relates, amongst many other things, to the inputting and/or synthesizing of data and automated decision-making equipment concerning the evaluation, rejection and/or acceptance of collateral-dependent consumer financing applications that enable lenders to once and for all break the indivisibility of real property assets. This can, for example, improve the automated systems used to evaluate the purchase of new homes, reduce the probabilities of default to which borrowers are exposed, and offer investors synthetic access to the otherwise illiquid and difficult to access residential property asset-class.

For many years, one has only been able to invest in the residential housing market by buying a home or investing in a rental property. However, as a result of the advances disclosed in International PCT Patent Publication No. WO2009/094694, there is also now new opportunities for investors to access synthetic exposures to portfolios of bundled, collateral-dependent consumer financing assets that have a rate of return tied to the performance of the underlying assets without incurring all of the transaction costs (such as stamp duty) associated with buying those assets outright.

In the United States, there are also residential property futures contracts tied to the Case-Shiller house price indices, wherein an investor can go long the index, and thereby benefit from any future capital appreciation, subject to there simultaneously being another party that is willing to go short the index, or somebody who wishes to benefit from future falls in the value of housing. This would likely include any party that wishes to hedge, or insure against, the risk of house price falls, which risk has been reinforced by the collapses in house prices in the US and UK during the global financial crisis.

Unfortunately, none of these historical antecedents have resolved various technical engineering difficulties to allow a computer based system to allocate capital to a house price index allowing diversification and low volatility returns. Thus, home owners too cannot access synthetic ‘equity finance’ to enable them to reduce their traditional debt burdens and draw on a safer mix of debt and equity when funding their real property purchases. Furthermore, reliable computer based systems for assessing; funding and managing collateral dependent loans are hitherto unknown.

The genesis of the invention is a desire to provide a computer-based system that overcomes or substantially ameliorates one or more of the disadvantages of the prior art, or to provide a useful alternative.

### SUMMARY OF THE INVENTION

According to a first aspect of the invention, there is provided a method of generating a digitally encoded electric waveform to determine whether an asset proposed to be added to a portfolio of assets should be added to said portfolio, or rejected, said method comprising the steps of:
partitioning the assets into a multiplicity of market segments;
calculating the current market value of each said segment;
determining, for a forecast distribution of future changes in market value of each said segment at predetermined future times, the value distribution of each said segment at said future times;
using said future segment value distributions to determine the portfolio value distribution at said future times to thereby establish a probability that the portfolio will exceed a benchmark portfolio return;
adding said proposed asset to each said segment in turn to obtain a modified value distribution of each said segment to thereby establish for each segment a probability that the modified portfolio will exceed the benchmark return; and
accepting the asset into the portfolio segments for which the probability of the modified portfolio return exceeding the benchmark return is greater than the probability that the original portfolio will exceed the benchmark return.

According to a second aspect of the present invention there is disclosed a method of identifying equity financed mortgage (EFM) applications causing a pre-originating portfolio of equity financed mortgages to progress toward a predetermined EFM portfolio model based on characteristics of one or more property price indices, said method comprising the steps of:
defining a current EFM portfolio over assets having origination values A₁⁰, . . . , Aₙ⁰, loan to valuation ratios (LVRs) l₁ . . . , lₙ with current ages T₁ . . . , Tₙ;
defining current EFM portfolio collateral assets having current values A₁ . . . , Aₙ, said current EFM portfolio collateral assets each having a value determined by a calculated valuation model;
defining said predetermined EFM portfolio model based on predetermined characteristics of a property price index subdivided into one or more predetermined classifications to define a total market value in each classification (V₁ . . . , Vₙ) determined by said calculated valuation model;
defining a target/index value proportion of each classification as the total market value of each classification divided by the sum of all the total market value of each classification;
defining a current EFM portfolio value (\tilde{V}ₖ) in each classification and multiplying same by a constant minimum annual return required from each EFM in the current EFM portfolio such that the current EFM portfolio value is summed over all classifications and the originating EFM value proportion for each classification is defined as the current EFM value proportion in each classification divided by the sum of the current EFM value proportion in each classification;
defining a notional distance as a function of said EFM value proportion and said current EFM portfolio value proportion, d(v, \tilde{v}) as the distance between the existing portfolio index value distribution and target/index value distribution such that d(v, \tilde{v})≧0;
obtaining a new current EFM portfolio value for each classification and recalculating said EFM value proportion for each classification; and
recalculating said distance d(v, \tilde{v}) with said recalculated EFM value proportion for each classification such that if said distance has increased the portfolio is further from said target/index portfolio than hitherto and said EFM application is therefore not automatically identified for acceptance, but is automatically identified for acceptance otherwise.

### BRIEF DESCRIPTION OF THE DRAWINGS

A preferred embodiment of the invention will be described, by way of example only, with reference to the drawings, in which:

FIG. 1 is a schematic block diagram of a general purpose computer upon which the preferred embodiment of the present invention can be practiced; and

FIG. 2 is a graph of a representative digitally encoded electronic signa.

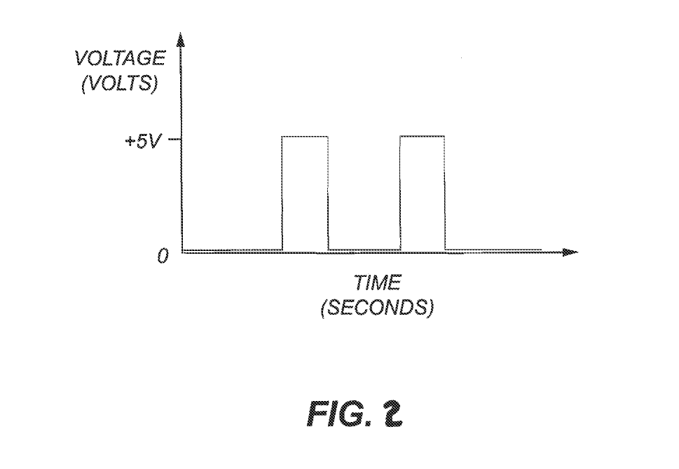

### DETAILED DESCRIPTION OF THE PREFERRED EMBODIMENTS

The preferred embodiment provides a computer-based system to enable the funding of collateral-dependent consumer finance loans using capital sourced from investors in entirely independent, index-linked house price products. This system advantageously allows for investors who want to allocate capital to a simple house price index, which offers them very well diversified and low volatility returns, and the desire of home owners to access synthetic ‘equity finance’ to enable them to reduce their traditional debt burdens and draw on a safer mix of debt and equity when funding their real property purchases.

The preferred embodiment of the invention also provides a computer-based system for processing data pertaining to the characteristics of collateral-dependent, consumer financing loans in order to determine whether said loans should be accepted or rejected in order to construct a portfolio of said loans that replicate the risk and return requirements of an independent house price index.

The preferred embodiment also allows for the provision of a computer-based system for managing the asset and liability matching requirements between a portfolio comprising products whose payoffs are tied to the performance of a house price index, and a portfolio comprising collateral-dependent loans that generate returns with a component independent of the index.

Building Block 1

An asset-selection system that takes in application data regarding equity finance mortgages (EFMs), compares that data to a model portfolio based on the characteristics of a house price index, and accepts/rejects EFM applications depending on whether they push the existing portfolio of EFMs (i.e. already originated) closer to the model portfolio and hence the index;

Assume the current portfolio contains EFMs over assets with origination values A₁⁰, . . . , Aₙ⁰, loan-to-valuation ratios (LVRs) l₁, . . . , lₙ and current ages T₁, . . . , Tₙ.

Assume the current portfolio EFM collateral assets have current values A₁, . . . , Aₙ, as determined by an automated valuation model (AVM)—see Patent specification WO2009/094694 the contents of which are incorporated into the present specification for all purposes.

Assume also that the index covers multiple regions (which may be defined via geography (e.g. census statistical areas) or price stratification or some other classification method) and the total market value in each region is V₁, . . . , Vₘ, (determined by an AVM), so that the “target” or index value proportion in each region is vₖ=Vₖ/ΣVₖ.

If c is the constant minimum annual required EFM return, we may add the EFM values in each region to obtain the current EFM portfolio value in each region as

$${\tilde{V}}_{k} = {\sum }_{i ∈ region} {𝓁}_{i} {A}_{i}^{0} \{ 1 + {cT}_{i} + 2 {( {A}_{i} / {A}_{i}^{0} - 1 - {cT}_{i} / 2 )}^{+} \}$$

and the EFM value proportion for each region as \tilde{v}ₖ=\tilde{V}ₖ/Σ\tilde{V}ₖ.

We define a notion of distance d(v,\tilde{v})≧0 between the existing portfolio and target/index value distributions \tilde{v} and v.

For example, one could use the L^{p} norm

$$d ( v , \tilde{v} ) = {\{ {\sum }_{k = 1}^{m} {\vert {\tilde{v}}_{k} - {v}_{k} \vert}^{p} \}}^{1 / p}$$

for p≧1 or the cross entropy

$$d ( v , \tilde{v} ) = {\sum }_{k = 1}^{m} {\tilde{v}}_{k} log ( {\tilde{v}}_{k} / {v}_{k} )$$

as a measure of distance.

Given an EFM application with LVR l over an asset with value A in region k, add this into the EFM portfolio to obtain a new region k value \tilde{V}ₖ+lA and recalculate the existing portfolio value distribution \tilde{v}.

Next recalculate the distance d(v,\tilde{v}) with the new \tilde{v}. If it has increased, the portfolio is further from the target portfolio than before and the application is sent for manual review or rejection.

In pseudo code:

1. Run the AVM (as disclosed in the above referenced patent publications)
to obtain values for all properties in database.
2. Read the values of all properties in the database into a vector P.
3. Read the location/region flag of all properties in the database
into a vector R.
4. Initialize a vector V = 0 of length n regions.
5. For i = 1 to length(P), add P(i) to entry R(i) of V.
6. Target proportion v = V/sum(V).
7. Read the values of all EFM properties in database into a vector A.
8. Read the origination values of all EFM properties in the database
into a vector A0.
9. Read the origination dates of all EFM properties in the database
into a vector D0.
10. Calculate the current lifetime values of all EFM properties in the
database as a vector T = Current date D − D0.
11. Read the LVRs of all EFM properties in the database into a vector L.
12. Read the location/region flag of all EFM properties in the database
into a vector RE.
13. Initialize a vector VE = 0 of length n regions.
14. for i = 1 to length(A)
Compute a(i) = max(0,A(i)/A0(i) − 1 − c*T(i)/2)
Compute E(i) = L(i)*A0(i)*(1 + c*T(i) + 2*a(i))
add E(i) to entry RE(i) of VE
15. Portfolio proportion ve = VE/sum(VE).
16. Calculate a distance d = dist(ve,v).
17. Read new EFM, LVR, L0, property value A0, region R0.
18. Add L0*A0 to entry R0 of VE.
19. New portfolio proportion ve0 = VE/sum(VE).
20. Calculate distance d0 = dist(ve0,v).
21. If d0 > d, refer for manual decision, else approve.

Building Block 1a

As an extension of (1) above, one wants to select and originate EFMs with expected returns (e.g. based on forecasts for geographic area/property type—include forecasts as an input variable) that have the highest probability of exceeding the return offered by a given property index, which is a variable that can be changed (e.g. index return=1.5× capital gains, or index return=capital gains+net rent).

The engineering problems to be solved are:
Given the following:
Origination EFM collateral asset values A₁⁰, . . . , Aₙ⁰.
Origination EFM LVRs l₁, . . . , lₙ.
Current EFM collateral asset values A₁, . . . , Aₙ.
Current EFM lifetimes T₁, . . . , Tₙ.
Portfolio segments or regions 1, 2, . . . , m and a vector R₁, . . . , Rₙ of regions for each EFM asset.
A constant c which is the minimum required percentage annual EFM return.
Individual property forecast (log) returns f₁, . . . , fₘ by segment where each fᵢ has mean gᵢ and standard deviation σᵢ.
A correlation matrix with (i,j)th entry ρ_{i,j} being the correlation between errors in forecast returns of properties in segments i and j.
Constants a, b so that the target portfolio return is ag+b, where g is the index return.
1. What is the probability p that the current portfolio will exceed the target return?
2. If we add an EFM with LVR l over an asset of current value A in each of the regions, what are the probabilities q₁, . . . , qₘ of exceeding the target return?
3. Which regions improve the target return and which one is optimal?

Note that solving the engineering problem in the general case i.e. with a variable distribution for the forecast errors, requires simulation. However, practical solutions include special cases where assumptions are made regarding the form of the error distribution, resulting in closed form, formula solutions. Any presentation of such a closed form solution is covered by such a simulation solution, however the converse is not true: that is, a closed form solution for a special case will not extend to a simulation solution for the general case.

To summarize, the process preferably entails a method of:
Calculating a distribution of value across a partition of a given market.
Calculating a distribution of value across the corresponding partition of a given portfolio.
Determining a distance between the portfolio and the market (examples of specific functions being given above).
Determining whether or not adding a proposed asset to the portfolio makes the new portfolio closer to, or further from, the market and using this calculated result as a criterion to make a business decision.

The process can contain an additional step in which there is valued a derivative portfolio i.e. one containing assets whose values derive from the values of a set of underlying assets. For example, in a portfolio of equity finance mortgages (or EFMs), the individual value of each EFM is derived from, or determined by, the value of the corresponding collateral property. The value of the portfolio of EFM's is the sum of the value of the individual EFM is in the portfolio. The method described can equally apply to any portfolio of derivative assets, for example option or futures contracts over stocks or commodities.

The advantages of this arrangement over the prior art are:
1. The ability of the system to incorporate a general notion of distance into the calculation, to calculate the distance between a portfolio and the market, and to decide whether a particular investment would move the portfolio closer to, or further from, the market. It is particularly advantageous to be able to use different notions of distance, representing differing overall investment goals, e.g. minimizing risk or maximizing return. For example, with respect to one goal, two portfolios may be close in distance, whilst they may be further apart with respect to another goal.
2. The ability of the system to handle a portfolio of derivative assets having a value with a general relationship to the underlying assets.
First note that the automated valuation model (AVM), as disclosed in a previous patent, may be used to value either a segment of, or the whole of, either a given portfolio or the entire market.

The first step is to partition the entire market into a set of “regions” or segments. These can be geographical, but other criteria can be used, for example property type or stratification by price. The AVM is used to calculate the proportions of market value in each region or segment. This vector of proportions is an initial target.

The above partition is then applied to a given portfolio(s), so that the proportions of value in the portfolio(s) are calculated. This step can be applied to any class of assets, including derivative ones.

Given a distance function, the distance between the market and portfolio value distributions is calculated. Then a “test asset” is added to a given region (or segment) and the portfolio value proportions recalculated. Then the distance between the new portfolio and the market portfolio is recalculated.

If the distance increases, adding the asset would push the portfolio further from the target portfolio and the investment decision is not accepted. The investment decision can be automatically rejected, or referred for further manual consideration.

Conversely, if the distance decreases, adding the asset would make the portfolio closer to the target portfolio, and so the investment is approved.

Specific Application to EFM Portfolio(s):

The value of an EFM is able to be calculated once the following are known:
A₀, the value of the property at origination;
l, the loan to value ratio (LVR) of the EFM amount lent to the property value;
A, the current value of the property;
T, the period of time since the EFM was originated, and
c,k, being contractual repayment parameters which apply to each EFM.

Thus, each EFM may be represented by a state vector (A₀,A,l,T). From this information and the values of c,k, the value of the EFM can be calculated.

This allows the calculation to be modified to obtain a distribution of value across the EFM portfolio, rather than just a portfolio of the underlying properties. The distance criterion is then applied in the same manner.

Specific Application to any Derivative Portfolio(s):

The value of each derivative asset will be calculable from a finite set of observable parameters (including time): namely (X₁, . . . , Xₙ,T). The value is then some function of these: V=f(X₁, . . . , Xₙ,T).

Once the values have been calculated, and the distribution of value across the derivative portfolio calculated, the calculation proceeds as for the EFM portfolio.

Building Block 2
1. Run the AVM (as per the abovementioned patent specification WO2009/094694) to obtain values for all properties in the database.
2. Read values of all properties in the database into a vector P.
3. Read the location/region flag of all properties in the database into a vector R.
4. Calculate a current index value I=sum(P)/length(P), or some other statistic of central tendency, such as the trimmed mean or median of vector P.
5. Read the values of all EFM properties in the database into a vector A.
6. Read the origination values of all EFM properties in the database into a vector A0.
7. Read the origination dates of all EFM properties in the database into a vector D0.
8. Calculate the current lifetime values of all EFM properties in the database as a vector T=Current date D−D0.
9. Read the LVRs of all EFM properties in the database into a vector L.
10. Read the location/region flag of all EFM properties in the database into a vector RE.
11. Initialize a vector VE=0 of length n regions.
12. for i=1 to length(A)

Compute a(i)=max(0,A(i)/A0(i)−1−c*T(i)/2)

Compute E(i)=L(i)*A0(i)*(1+c*T(i)+2*a(i))
Note that the vector E is the current EFM values
13. Calculate IE=sum(E)/length(E) or some other statistic of central tendency, such as the trimmed mean or median of E. Note that EI is an index representing the value of the EFM portfolio.
14. Read in a vector of regional forecast means g, a vector of regional forecast standard deviations σ, and a regional correlation matrix ρ.

Simulation:

for path=1 to n paths
i. Use R, g, σ, and ρ to generate a vector F of forecast log returns for all properties in the database. A subset FE of the vector F will be the properties in the EFM portfolio.
ii. Calculate a vector of future property values

P1=P*exp(F)
and get the subset A1 of future EFM property values.
iii. Calculate the future index value

I1=sum(P1)/length(P1)
iv. Calculate the future index return for this path

Y(path)=I1/I−1
v. Compute T1=T+h where h is the forecast horizon
   for i=1 to length(A)

Compute a1(i)=max(0,A1(i)/A0(i)−1−c*T1(i)/2)

Compute E1(i)=L(i)*A0(i)*(1+c*T1(i)+2*a1(i))
Note that the vector E1 is the future EFM values.
vi. Calculate the future EFM index value

IE1=sum(E1)/length(E1)
vii. Calculate the future EFM portfolio return for this path

YE(path)=IE1/IE−1
viii. for i=1 to n regions
   Draw a random future return f(i) from a property in region i in the vector F\FE.
   Note that this gives a new property in each region which is not a member of the existing EFM portfolio
   Note that now one adds a new EFM with LVR L1 over a property with value V to each region, one at a time.
ix. Calculate the current EFM index value with the new EFM added

JE=(sum(E)+L1*V)/(length(E)+1)−1
x. for i=1 to n regions

Compute a2(i)=max(0,exp(f(i))−1−c*h/2)

Compute E2(i)=L1*V*(1+c*h+2*a2(i))
Note that the vector E2 is the future EFM values for the same EFM added to each region.
Calculate the new future EFM index value for each region

JE2(i)=(sum(E1)+E2(i))/(length(E1)+1)
xi. Calculate the new future EFM portfolio return for each region and this path
   for i=1 to n regions

YE2(path,i)=JE2(i)/JE−1

Output calculations:
16. Count p=the number of positive entries of YE−a*Y−b
   Note that p estimates the probability of the current portfolio exceeding the benchmark return.
17. for i=1 to n regions

Count q(i)=the number of positive entries of YE2(:,i)−a*Y−b
Note that q(i) estimates the probability of the portfolio with the extra EFM added to region i, exceeding the benchmark return.
Note that all regions i with q(i)>p will improve the portfolio. Accept any EFM in these regions

To summarize, the process preferably entails a method of:
Using the set of current asset values, and a set of segment forecasts, to calculate distributions of market and portfolio returns over the forecast horizon.
Calculating the probability that the return on the existing portfolio over the forecast horizon exceeds a function of the market (index) return (which can be regarded as a benchmark).
Given a proposed investment amount, (independently) adding this asset to each market segment and calculating the set of probabilities of the amended portfolios exceeding the benchmark.
Making a business decision on investment acceptance or rejection based on which market segments increase and decrease the probability of exceeding the benchmark.

As in Building Block 1, the process can contain an additional step in which there is valued a derivative portfolio, for example EFMs.

The advantages of this arrangement are:
1. The ability of the system to take a set of market segment forecasts (together with their statistical parameters, such as correlations) and calculate the probability of portfolio returns exceeding a pre-defined benchmark (which need not be constant; it may be a function of the market return, for example 110% of the market+2.5%).
2. The ability of the system to test the effect of making an additional investment in each market segment and enable a decision to be made as to which segments improve the outcome.
3. The ability of the system to handle a portfolio of derivative assets having a general relationship to the underlying ones.

As in Building Block 1, the procedure begins by partitioning both the market and portfolio, then using an AVM to calculate the proportions of market value in each region or segment.

Given a set of market segment forecasts, or more correctly, a set of parameters representing these forecasts, for example (g,Σ), where g is a vector of forecast mean segment returns and Σ is a matrix of return correlations, these are then used to simulate future values of the underlying assets and hence the future values of any derivative assets which comprise the portfolio.

The process then calculates the portfolio and market return distributions and hence the probability (p₀) of the portfolio return exceeding the benchmark over the forecast horizon.

The process is repeated in a loop over all segments, with the proposed investment added to a different segment in each loop step, obtaining a probability for each segment. These probabilities (pᵢ) are then compared with p₀ and investments in segments i with pᵢ>p₀ approved.

Building Block 3.

More complex asset/liability matching can be achieved by coding for different hedging systems that manage the payoffs owed under an index-linked structured product and the returns generated by a portfolio of EFMs. System output is the $ value of EFMs required at any given point in time to satisfy a predetermined hedging objective:
Static hedging is the simplest goal, given the $ value of structured product written at any point in time, generate the $ value of EFMs that exactly match.

Note that the EFM returns will never exactly match the structured product returns. The computation does not have a physical counterpart as the structured product is over an index, which can therefore only ever be a partial hedge to the EFM portfolio, or vice versa.

To summarize, the process preferably deals with the problem of structuring a portfolio of assets (including derivatives such as EFMs), together with an index linked note (referred to as a structured product) which is sold or issued. The arrangement is such that the returns of the note partially hedge the risk of the portfolio. It provides a method of either optimizing or returning an acceptable range of ratios Δ of structured product issued to EFMs (or other assets) invested in, so that some aspect of overall return is either maximized or exceeds a given hurdle rate.

The process is a method of:
Using the set of current asset values and a set of segment forecasts to calculate distributions of market and portfolio returns over the forecast horizon;
For each Δ in a feasible set of hedge ratios, calculating the corresponding distribution of overall position (EFM portfolio+structured product issue) returns;
Given a function of the overall position return, for example the expected return or the 90^{th} percentile return, calculating the optimal Δ, or a range of acceptable Δ, to meet a given hurdle rate, and
Using the calculated ratio to make a business decision to issue more or less structured product relative to the EFMs (or other asset or portfolio of assets).

The advantages of this arrangement are:
1. The ability of the system to take a set of market segment forecasts (together with their statistical parameters, such as correlations) and calculate return distributions on a complex, structured position, for a range of hedge ratios.
2. To automate an investment decision by determining either an optimal hedge ratio or an acceptable range of hedge ratios.

The following solves a more general problem.

Building Block 4.

What is needed is a criterion for choosing the ratio of the structured product to the EFM assets (the delta) which maximizes some function of the excess profit.

Assume we have an index linked structured product which returns ag+b, where g is the index return, and a and b are numerical values. For example, if a=1, b=0.03, this would be a return of the capital gain on the index plus a fixed 3% rental yield. Note that a, b could have random components, for example if b represented a variable, market rental yield.

Assume the b value includes management fees deducted e.g. if the product paid capital gains on the index plus a fixed 3% rental yield, less a 1% fee. Then a=1, b=0.02.

Assume that for each $ of EFMs, $ Δ of the structured product is issued.

The $ Δ paid by investors is invested at the interest rate r₀. Alternatively, if the structured product is leveraged with gearing G, the income to the fund comes from investing $(1−G)Δ at the rate r₀ and receiving from the structured product customers an interest rate of r₁.

Write r=(1−G) r₀+Gr₁ for the all up interest return to the fund on the structured product issuance.

Write r_{f} for the funding cost of the capital to lend out as EFMs. Note that if Δ≧1 and the EFMs are funded entirely by the structured product issued, then r_{f}=r, however the preferred embodiment solves the more general problem (which includes this case), where funding sources are allowed to differ.

Assume in the first case that since a new EFM portfolio is being originated, that it is weighted in each region/segment in proportional to the index/market portfolio.

Assume that n EFMs are originated with LVRs l₁, . . . , lₙ over collateral assets with initial values A₁⁰, . . . , Aₙ⁰.

The computation is via simulation, as the joint asset return process may be arbitrary.

For each path: and

For Δ in range of deltas:
Given a set of property market parameters, for example (at least) the expected growth rate and volatility of each property, plus a regional correlation matrix as in the previous example, generate a vector of log returns dA for each property in the EFM portfolio and a larger vector of log returns dP for the entire market.
The future value of each property is given by Aᵢ(T)=Aᵢ(0)exp {dAᵢ}.
The payoff per dollar invested in the EFM portfolio is

$${P}_{T} = {\sum }_{i = 1}^{n} {𝓁}_{i} {A}_{i} ( 0 ) [ ( 1 + cT ) + 2 {( {A}_{i} ( T ) / {A}_{i} ( 0 ) - ( 1 + cT / 2 ) )}^{+} ] / {\sum }_{i = 1}^{n} {𝓁}_{i} {A}_{i} ( 0 )$$

where c is the minimum required EFM return p.a. and T is the time horizon
Use the regional weightings in the market index to generate a market index return g from the vector of individual property returns.
Calculate the structured product fund income I_{T} as I_{T}=Δ(r−ag−b)T.
The total income per dollar invested on the hedged EFM portfolio is H_{T}=P_{T}−r_{f}T+I_{T}. This is a deterministic value in each sample path, but a random variable over all paths.
Choose the value of A which maximizes a pre-determined functional of H (which may be chosen from a list of many functionals at run-time). For example, we may wish to maximize the 5^{th} percentile of H. In this case, for each Δ, calculate the 5^{th} percentile H_{0.05}(Δ) of all values of H over all sample paths for this Δ value. Now choose the value of Δ which maximizes H_{0.05}(Δ)
1. Run the AVM (as per the disclosure of WO 2009/094694) to obtain values for all properties in the database.
2. Read values of all properties in the database into a vector P.
3. Read the location/region flag of all properties in the database into a vector R.
4. Calculate the current index value I=sum(P)/length(P) or some other statistic of central tendency, such as the trimmed mean or median of P.
5. Set the EFM portfolio value S and funding cost rf.
6. Set a vector of test range of feasible Δ values.
7. Set the structured product return parameters a,b.
8. Set the gearing ratio G and returns r0, r1.
9. Calculate r=(1−G)*r0+G*r1.
10. Calculate the EFM portfolio to market proportion=S/sum(P).
11. for j=1 to n regions
   Randomly select π*n(j) properties for the EFM portfolio from region j, where n(j) is the total number of properties in region j
12. Read the origination values of all EFM properties in selection in Step 7 into the vector A0.
13. Set the time horizon T.
14. Read the LVRs of all EFM properties in selection in Step 7 into a vector L.
15. Read the location/region flag of all EFM properties in selection in Step 7 into a vector RE.
16. Initialize a vector VE=0 of length n regions.
17. Read in a vector of regional forecast means g, a vector of regional forecast standard deviations, and a regional correlation matrix p.
18. Simulation:
   for path=1 to n paths
i. Use R, g, σ, and ρ to generate a vector F of forecast log returns for all properties in the database. A subset FE of the vector F will be the properties in the EFM portfolio.
ii. Calculate a vector of future property values

P1=P*exp(F)
and get the subset A1 of future EFM property values.
iii. Calculate the future index value

I1=sum(P1)/length(P1)
iv. Calculate the future index return for this path

Y(path)=I1/I−1
v. for i=1 to length(A0)

Compute a1(i)=max(0,A1(i)/A0(i)−1−c*T/2)

Compute E1(i)=L(i)*A0(i)*(1+c*T+2*a1(0)
Note that the vector E1 contains the future EFM values.
vi. Calculate the future EFM portfolio value

IE1=sum(E1)
vii. Calculate the future EFM portfolio return for this path

YE(path)=IE1/sum(L*A0)−1
viii. for j=1 to length(Δ)

Calculates J=Δ(j)*(r*T−a*Y(path)−b*T)

H(path,j)=YE(path)−rf*T+J
Note that H is the total fund return for each given Δ

Output calculations:
19. for j=1 to length(Δ)
   Calculate the required statistical function of H(:,j) and write it to Z(j).
   Note that the statistical function could be a mean or median or other percentile, for example
20. Return Δ(j) where j maximizes Z(j).
   a. Dynamic hedging: given (a) the mark-to-market value of the liabilities owing under a portfolio of structured products (revalued using our index), where total liabilities determined by the return structure of the structured product (e.g. 1.5×index or index+net rent), and (b) desire to minimize $ value of EFMs held on balance-sheet to meet structured product obligations, dynamically determine on a periodic basis the optimal $ value of EFMs to meet those mark-to-market obligations (subject to a limit that one can never originate more $ value EFMs than funds one has raised by structured products).
      i. Comment 1: As the index rises, EFM values may grow faster than liabilities owing under structured products, and one does not therefore need as many EFMs;
      ii. Comment 2: One asset-selection rule for EFMs should be that the EFMs have expected holding periods that as closely as possible match the duration of the structured products that have been originated (e.g. select more first time buyers or elderly people);
   iii. Comment 3: In the system code, structure an alternative or option whereby if structured product redemptions are higher than the system's a priori expectations, the system can automatically offer EFM borrowers incentives to repay more quickly (e.g. reduced upside sharing for a short 3-6 month window);
   b. Strategic hedging: Subject to a limit that one can never originate more $ value EFMs than funds one has raised by structured products, the system selects EFMs that maximizes excess returns that can be generated by EFMs over and above liabilities owing under structured products, as determined on a mark to market basis at every point in time (i.e. one may run partially “naked” positions given the expected returns of EFMs). So the system selects certain EFMs based on expected returns, volatility etc, that have the highest probability of (a) meeting liabilities owing under structured products and (b) producing excess returns over and above these

The notation of the static hedging section will be used in the dynamic hedging calculation.

Assume an existing portfolio of EFMs, which may deviate in weighting from the index or market portfolio. Assume the current value of the EFM portfolio is E(t). Assume also that a given value of structured product is issued, with ratio Δₜ to the value EFM portfolio.

Let Aᵢ(tᵢ) be the origination times and values of the EFM properties. Then

$$E ( t ) = {\sum }_{i = 1}^{n} {𝓁}_{i} {A}_{i} ( {t}_{i} ) [ ( 1 + c ( t - {t}_{i} ) ) + 2 {( {A}_{i} ( t ) / {A}_{i} ( {t}_{i} ) - ( 1 + c ( t - {t}_{i} ) / 2 ) )}^{+} ]$$

Given a set of property market parameters, for example (at least) the expected growth rate and volatility of each property, plus a regional correlation matrix as in the previous example, generate a vector of log returns dA for each property in the EFM portfolio and a larger vector of log returns dP for the entire market, each over the same time horizon T.

The future value of each EFM property is given by Aᵢ(t+T)=Aᵢ(t) exp {dAᵢ}.

The future EFM portfolio value is

$$E ( t + T ) = {\sum }_{i = 1}^{n} {𝓁}_{i} {A}_{i} ( {t}_{i} ) [ ( 1 + c ( t + T - {t}_{i} ) ) + 2 {( \begin{matrix}{A}_{i} ( t + T ) / {A}_{i} ( {t}_{i} ) - \\ ( 1 + c ( t + T - {t}_{i} ) / 2 )\end{matrix} )}^{+} ]$$

If P₁, . . . , P_{N} are all the properties in the market (or which make up the index), the index return over the period t→t+T is

$$g = {\sum }_{i = 1}^{N} {P}_{i} ( t ) exp \{ {dP}_{i} \} / {\sum }_{i = 1}^{N} {P}_{i} ( t ) - 1$$

At the current level of EFM and SP issuance, the return on the entire position over the period t→t+T is

H=E(t+T)/E(t)−1−r_{f}T+Δᵢ(r−ag−b)

Assume first that some more structured product is issued, but no more EFMs.

Then the new hedge ratio of SP:EFM is Δ>Δₜ and the new all up return will be

H*=E(t+T)/E(t)−1−r_{f}T+Δ(r−ag−b)

Assume that more EFMs are issued over properties with values Aₙ₊₁(t), . . . , Aₙ₊ₘ(t) at time t. Suppose over the period t→t+T these values then change to the random quantities Aₙ₊₁(t+T), . . . , Aₙ₊ₘ(t+T).

Then the current EFM portfolio value is

$${E}^{*} ( t ) = {\sum }_{i = 1}^{n} {𝓁}_{i} {A}_{i} ( {t}_{i} ) [ ( 1 + c ( t - {t}_{i} ) ) + 2 {( \begin{matrix}{A}_{i} ( t ) / {A}_{i} ( {t}_{i} ) - \\ ( 1 + c ( t - {t}_{i} ) / 2 )\end{matrix} )}^{+} ] + {\sum }_{i = n + 1}^{n + m} {𝓁}_{i} {A}_{i} ( {t}_{i} )$$

and the future EFM portfolio value is

$${E}^{*} ( t + T ) = {\sum }_{i = 1}^{n + m} {𝓁}_{i} {A}_{i} ( {t}_{i} ) [ ( 1 + c ( t + T - {t}_{i} ) ) + 2 {( \begin{matrix}{A}_{i} ( t + T ) / {A}_{i} ( {t}_{i} ) - \\ ( 1 + c ( t + T - {t}_{i} ) / 2 )\end{matrix} )}^{+} ]$$

where tᵢ=t for i=n+1, . . . , n+m.

In the most general case, some more structured product could also be issued as well.

Whether this is done or not, the new hedge ratio will be Δ, which could be greater than, less than, or even by chance equal to Δ.

The new all up return will be

H*=E*(t+T)/E*(t)−1−r_{f}T+Δ(r−ag−b)

The first objective is to determine the value of Δ which maximizes a pre-determined functional φ(H) (which may be chosen from a list of many functions at run-time).

If Δ>Δₜ the objective will be met by issuing more structured product. Note that this does not mean one cannot issue more EFMs, as long as φ(H) stays above an acceptable limit.

If Δ≦Δₜ, the objective will be met by writing more EFMs.

There are two distinct questions here:

(i) What is the range of Δ so that φ(H) is within acceptable limits?

(ii) What is the value of Δ which optimizes φ(H)?
1. Run the AVM (according to the disclosure of WO 2009/094694) to obtain values for all properties in the database.
2. Read the values of all properties in the database into a vector P.
3. Read the location/region flag of all properties in the database into a vector R.
4. Calculate the current index value I=sum(P)/length(P), or some other statistic of central tendency, such as the trimmed mean or median of P.
5. Set EFM funding cost rf.
6. Set a vector of a test range of feasible Δ values.
7. Set structured product return parameters a,b.
8. Set gearing ratio G and returns r0, r1.
9. Calculate r=(1−G)*r0+G*r1.
10. Read the origination values of all EFM properties in the current portfolio into a vector A0.
11. Read the current values of all EFM properties in the current portfolio into a vector A.
12. Read the origination dates of all EFM properties in the database into a vector D0.
13. Calculate the current lifetime values of all EFM properties in the database as a vector ti=Current date D−D0.
14. Read the LVRs of all EFM properties in the database into a vector L.
15. Read the location/region flag of all EFM properties into a vector RE.
16. Set the time horizon T.
17. Initialize a vector VE=0 of length n regions.
18. for i=1 to length(A)

Compute a(i)=max(0,A(i)/A0(i)−1−c*ti(i)/2)

Compute E(i)=L(i)*A0(i)*(1+c*ti(i)+2*a(i))
Note that the vector E contains the current EFM values.
19. Calculate IE=sum(E)/length(E) or some other statistic of central tendency, such as the trimmed mean or median of E. Note that EI is an index representing the value of the EFM portfolio.
20. Get SP=$ total structured product currently issued
21. Calculate current delta ratio Δt=SP/sum(E)
22. Read in a vector of regional forecast means g, a vector of regional forecast standard deviations σ, and a regional correlation matrix ρ.
23. Simulation:
for path=1 to n paths
   i. Use R, g, σ, and ρ to generate a vector F of forecast log returns for all properties in the database. A subset FE of the vector F will be the properties in the EFM portfolio.
   ii. Calculate a vector of future property values

P1=P*exp(F)
and get the subset A1 of future EFM property values.
iii. Calculate the future index value

I1=sum(P1)/length(P1)
Calculate the future index return for this path

Y(path)=I1/I−1
iv. for i=1 to length(A0)

Compute a1(i)=max(0,A1(i)/A0(i)−1−c*(ti(i)+T)/2)

Compute E1(i)=L(i)*A0(i)*(1+c*(ti(i)+T)+2*a1(i))
Note that the vector E1 contains the future EFM values.
v. Calculate the future EFM portfolio index value

IE1=sum(E1)/length(E1)
vi. Calculate the future EFM portfolio return for this path

YE(path)=IE1/IE−1
vii. for j=1 to length(Δ)

Calculate J=Δ(j)*(r*T−a*Y(path)−b*T)

H(path,j)=YE(path)−rf*T+J
Note that H is the total fund return for each given
Note the returns on any new EFM issuance:
viii. for k=1 to n regions
   Select m properties at random from value vector P where region in vector R=k.
   Write their current values to a vector B0.
   From vector P1, get the corresponding future values. Write these values to a vector B.
   Set an LVR value Lb.
   for kk=1 to m

Compute b1(kk)=max(0,B(kk)/B0(kk)−1−c*T/2)

Compute EB(k,kk)=Lb*B0(kk)*(1+c*T+2*b1(kk))
Note that EB contains the future EFM values.
ix. for k=1 to n regions
   Calculate the future EFM portfolio return for region

YEB(k)=sum(EB(k,:))/sum(Lb*B0)−1

Output calculations:
24. for j=1 to length(Δ)
   Calculate the required statistical function of H(:,j) and write it to Z(j).
   Find jt=value of j where Δ(j)=Δt.
   Note that the statistical function could be a mean or median or other percentile, for example.
25. Return Δopt=Δ(j) where j maximizes Z(j) and value Zt=Z(jt).
26. If Δopt>Δt, more structured product should be issued.
   The $ amount extra to be issued is SP*(Δopt/Δt−1) where SP is the current amount issued in Step 20.
   If Δopt<Δt, more EFMs should be issued.
   The $ amount of extra EFMs to be issued is

SP*(1/Δopt−1/Δt).
27. In the case of issuing more EFMs, one can optimize the return by only selecting EFMs in the regions for which

YEB(k)>rf*T+Δopt*(r−a*mean(Y)−b)
where Y is calculated in Step 23(iii).

Notes: The calculations in Step 26 cover the situation where some EFMs in the existing portfolio have increased in value since origination and hence a $1 movement in the property index will equate to more than a $1 movement in the EFM portfolio, regardless of direction.

The amount of extra structured product or EFMs to be issued to maintain the optimal hedge is covered by the calculation.

Some additional concepts are noted starting with “Locking in profits” on structured products.
To lock in profits created by an up market which is well above 100 (100 being the index value at origination). If EFMs have outperformed SP/D, because EFMs take 2× the ups, they will also fall 2× from their elevated position from a P&L perspective, whereas the Index Linked Structured Products/Derivatives (“SP/Ds”) will only fall 1×. Thus, if the EFM portfolio value has grown from 100 to 160 while SP/D have only grown from 100 to 130, the issuer has booked a profit of 30 (ignoring rent of the SP/D which should have been covered by the interest on the $100 from the SPD investor sitting in the issuer's account). To ensure that a P&L loss of 30 is not recognized if index falls back to 100, then one needs to originate another 30 of SP/Ds so that a hold value is equal to 130+30=160. Now if the index falls back to 100, the profit is 60 on SP/Ds and the loss is 60 on EFMs, i.e. the net is zero from the elevated position and one has locked in the 30 of profit reported in the prior period.
In an up market the hedging mechanism outlined above will lower returns, but, remove potential future P&L volatility.
If the market falls below the issue price, then the issuer of SP/D makes profits (say if the index falls from 100 to 80, the issuer makes a mark-to-market profit of 20 in the P&L for the year), but, when the market then goes back to 100, because the issuer recognized a profit of 20 last year, then the issuer must now recognize a loss of 20 this year. Thus to lock in profits, after the market has fallen below the origination point, if one's forecasts indicate that the market is about to start growing again, then one wants as little SP/D on one's books as possible. That is, if below 100, let the SP/D run-off, don't try to match the book values as in the example above. Also if one doesn't get the desired run-off of the SP/Ds, then originate a lot of new EFMs and get relatively over weight new EFMs. The reason being that old SEMs just sit at 100. If the market falls from 100, the borrower just has to repay 100—thus there is no profit on EFMs as the market increases back from say 80 to 100. But, on the SP/D side, one recognizes a loss as the index goes back from 80 to 100. However, if one issues new EFMs with a basis of 80, then one profits as the market goes from 80 back to 100. This should offset losses on the SP/D position if one hasn't been able to get rid of SP/Ds at 80

Being as closely dynamically hedged as possible mitigates the P&L risk, but, also limits P&L profits. If one considers the EFM vs SP/D chart of returns, with the gap being the profit, then the dynamic hedging basically means that one always get close to the smallest gap. One doesn't get the huge gaps at the very high and very low HPI outcomes.

Given the combination of interest rates on cash held by the issuer of the SP/Ds, the rent paid on the SP/Ds, EFM upside share, and the SP/D 1-1-1 or 1-1-0 capital pay-offs, then the most profitable P&L may be achieved by running skews in the value of one book relative to the other. The skew which achieves the best profit while also achieving hedging objectives will also depend on the expected movement in the market over a given P&L reporting period. Direction shouldn't matter as one can still lock in profits, but, absolute expected movement needs to be factored in.

To summarize, the process preferably deals with the problem of dynamically adjusting a mature portfolio of the type created in Building Block 3. By this, is meant, in effect, dynamically adjusting the hedge ratio Δ by issuing a greater or lower proportion of EFMs to index linked notes (or structured product).

The process adds the following elements to Building Block 3:
The ability to add new assets to an existing portfolio of EFMs (or other asset type), and then dynamically recalculate the hedge ratio (either the optimal ratio or an acceptable range of ratios), and
Calculate how much extra (if any) structured product should be issued

The advantage of this arrangement over Building Block 3 is to dynamically recalculate the hedge ratio as the portfolio is live and assets are continually entering and exiting the portfolio (rather than at the initial build of the portfolio). This enables real time optimization of portfolios of the types discussed in this patent application.

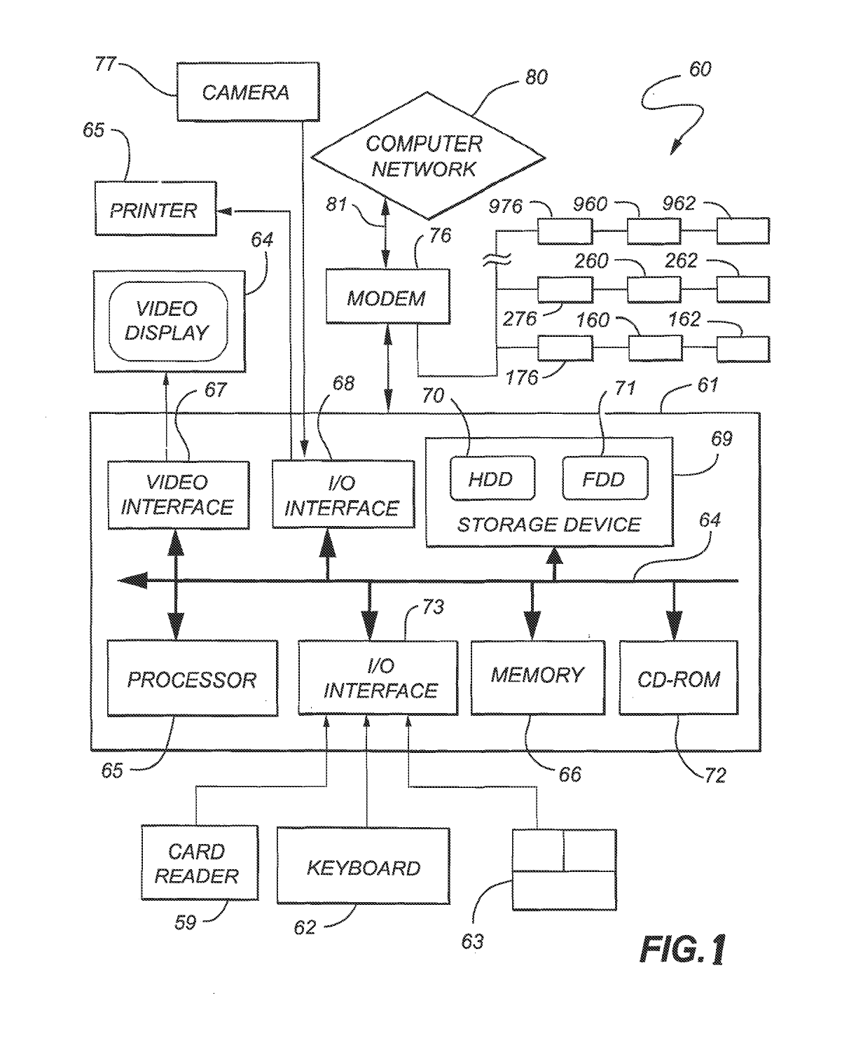

The above described methods are preferably practiced using a conventional general-purpose computer system 60, such as that shown FIG. 1 wherein the above described methods can be implemented as software, such as an application program executed within the computer system 60. In particular, the steps of the methods are given effect, or implemented, by instructions in the software that are carried out by the computer. The software may be divided into two separate parts; one part for carrying out the methods; and another part to manage the user interface between the latter and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer creates an advantageous apparatus for carrying out the embodiments of the invention.

The computer system 60 comprises a computer module 61, input devices such as a keyboard 62 and mouse 63, and output devices including a printer 65 and a display device 64. A Modulator-Demodulator (Modem) transceiver 76 is used by the computer module 61 for communicating to and from a communications network 80. For example, the computer module 60 is connectable via a telephone line 81 or other functional medium. The modem 76 can be used to obtain access to the Internet, and other network systems, such as a Local Area Network (LAN) or a Wide Area Network (WAN).

The computer module 61 typically includes at least one processor unit 65, a memory unit 66, for example formed from semiconductor random access memory (RAM) and read only memory (ROM), input/output (I/O) interfaces including a video interface 67, and an I/O interface 73 for the keyboard 62 and mouse 63 and optionally a joystick (not illustrated), and an interface 68 for the modem 76. A storage device 69 is provided and typically includes a hard disk drive 70 and a floppy disk drive 71 (or equivalent). A magnetic tape drive (not illustrated) may also be used. A CD-ROM drive 72 is typically provided as a non-volatile source of data. The components 65 to 73 of the computer module 61, typically communicate via an interconnected bus 64 and in a manner which results in a conventional mode of operation of the computer system 60 known to those in the relevant art. Examples of computers on which the embodiments can be practiced include IBM-PC's and compatibles, Sun Sparcstations or a like computer systems evolved therefrom.

Typically, the application program of the preferred embodiment is resident on the hard disk drive 70 and read and controlled in its execution by the processor 65. Intermediate storage of the program (and any data from the network 80) may be accomplished using the semiconductor memory 66, possibly in concert with the hard disk drive 70. In some instances, the application program may be supplied to the user encoded on a CD-ROM or floppy disk and read via the corresponding drive 72 or 71, or alternatively may be ready by the user from the network 80 via the modem device 76. Still further, the software can also be loaded into the computer system 60 from other computer readable media including magnetic tape, a ROM or integrated circuit, a magneto-optical disk, a radio or infra-red transmission channel between the computer module 61 and another device, a computer readable card such as a PCMCIA card, and the Internet and Intranets including email transmissions and information recorded on websites and the like. The foregoing is merely exemplary of relevant computer readable media. Other computer readable media may be practiced without departing from the scope and spirit of the invention.

It should not be lost sight of that the purpose of the computer system 60 is to generate a digitally encoded electronic signal (such as that illustrated in FIG. 6) which when applied to an output interface (such as the display device printer 65) produces an indicium or indicia which convey information and which are legible or intelligible to a human. For example, the electronic signal illustrated in FIG. 6 is a binary encoded signal 01001 which when applied to the display device 64 or printer 65 causes the indicium 9 to be displayed or printed.

The above described methods can alternatively be implemented in dedicated hardware such as one or more integrated circuits performing the requisite functions or sub functions. Such dedicated hardware can include graphic processors, digital signal processors, or one or more microprocessors and associated memories.

### INDUSTRIAL APPLICABILITY

It is apparent from the above that the embodiment(s) of the invention are applicable to the electrical engineering matrix which underpins modern financial systems with their data processing requirements.

The foregoing describes only some embodiments of the present invention, and modifications and/or changes can be made thereto without departing from the scope of the present invention. The description of the preferred embodiments is to be understood as being illustrative and not restrictive.

In the context of this specification, the word) “comprising” means “including principally but not necessarily solely” or “having” or “including” and not “consisting only of”. Variations of the word comprising, such as “comprise” and “comprises” have corresponding meanings.

While the principles of the invention have been described above in connection with preferred embodiments, it is to be clearly understood that this description is made only by way of example and not as a limitation of the scope of the invention.

1. A method of generating a digitally encoded electric waveform to determine whether an asset proposed to be added to a portfolio of assets should be added to said portfolio, or rejected, said method comprising the steps of:
partitioning the assets into a multiplicity of market segments;
calculating the current market value of each said segment;
determining, for a forecast distribution of future changes in market value of each said segment at predetermined future times, the value distribution of each said segment at said future times;
using said future segment value distributions to determine the portfolio value distribution at said future times to thereby establish a probability that the portfolio will exceed a benchmark portfolio return;
adding said proposed asset to each said segment in turn to obtain a modified value distribution of each said segment to thereby establish for each segment a probability that the modified portfolio will exceed the benchmark return; and
accepting the asset into the portfolio segments for which the probability of the modified portfolio return exceeding the benchmark return is greater than the probability that the original portfolio will exceed the benchmark return

2. The method of claim 1 wherein said assets are derivatives of physical assets and derive their market value from the market value of the physical assets.

3. The method of claim 2 wherein said derivative assets are mortgages.

4. The method of claim 3 wherein said mortgages are equity finance mortgages.

5. The method of claim 4 including the further step of calculating the quantum of structured notes having a value linked to an index of the property assets underlying said equity finance mortgages whereby the value of the liabilities created by said structured notes and said equity finance mortgages are approximately equal.

6. The method of claim 5 including the further step of dynamically adjusting the portfolio of equity finance mortgages and the quantum of said structured notes to maintain the value of said liability approximately equal over time.

7. A method of identifying equity financed mortgage (EFM) applications causing a pre-originating portfolio of equity financed mortgages to progress toward a predetermined EFM portfolio model based on characteristics of one or more property price indices, said method comprising the steps of:
defining a current EFM portfolio over assets having origination values A₁⁰, . . . , Aₙ⁰, loan to valuation ratios (LVRs) l₁ . . . , lₙ with current ages T₁ . . . , Tₙ;
defining current EFM portfolio collateral assets having current values A₁ . . . , Aₙ, said current EFM portfolio collateral assets each having a value determined by a calculated valuation model;
defining said predetermined EFM portfolio model based on predetermined characteristics of a property price index subdivided into one or more predetermined classifications to define a total market value in each classification (V₁ . . . , Vₙ) determined by said calculated valuation model;
defining a target/index value proportion of each classification as the total market value of each classification divided by the sum of all the total market value of each classification;
defining a current EFM portfolio value (\tilde{V}ₖ) in each classification and multiplying same by a constant minimum annual return required from each EFM in the current EFM portfolio such that the current EFM portfolio value is summed over all classifications and the originating EFM value proportion for each classification is defined as the current EFM value proportion in each classification divided by the sum of the current EFM value proportion in each classification;
defining a notional distance as a function of said EFM value proportion and said current EFM portfolio value proportion, d(v, \tilde{v}) as the distance between the existing portfolio index value distribution and target/index value distribution such that d(v, \tilde{v})≧0;
obtaining a new current EFM portfolio value for each classification and recalculating said EFM value proportion for each classification; and
recalculating said distance d(v, \tilde{v}) with said recalculated EFM value proportion for each classification such that if said distance has increased the portfolio is further from said target/index portfolio than hitherto and said EFM application is therefore not automatically identified for acceptance, but is automatically identified for acceptance otherwise.

8. A method as claimed in claim 7 further identifying for origination EFM applications with predetermined expected returns that have the highest probability of exceeding the return offered by a given variable property price index, each said classification being a geographic region and/or property type and said property price index being dependent thereon, the method comprising the steps of:
defining EFM portfolio regions 1, 2, . . . , m and a vector R₁, . . . , Rₙ of regions for each EFM asset;
defining individual property forecast returns f₁, . . . , fₘ by region where each fᵢ has a mean gᵢ and a standard deviation σᵢ;
defining a correlation matrix with an (i,j)th entry ρ_{i,j} being the correlation between errors in forecast returns of properties in regions i and j;
defining parameters a, b so that the target portfolio return is ag+b, wherein g is the given variable house price index return;
adding an EFM with LVR l over a property of current value A in each of the regions and determining the probabilities q₁, . . . , qₘ of exceeding the expected return and/or determining EFMs for properties in regions which improve the target/index return; and
determining the probability of whether the current EFM portfolio will exceed said target/index return.

9. A method as claimed in claim 8 including the step of identifying and accepting for origination EFM applications by determining the probability of whether the current EFM portfolio in any region will exceed said target/index return upon acceptance of the EFM application, wherein qᵢ estimates the probability of the portfolio with the extra EFM if accepted added to region i exceeding the target/index return such that all classification regions i with qᵢ>p will improve the portfolio and accept for origination any EFM application in these regions.

10. A method as claimed in claim 7 wherein said predetermined classifications upon which said property price index are dependent are selected from the class consisting of geography, price, property type, and property size.

11. A method as claimed in claim 7 wherein recalculating said distance d(v,\tilde{v}) with said recalculated EFM value proportion for each classification such that if said distance has increased the portfolio is further from said target portfolio/index than hitherto and said EFM application is not automatically identified for acceptance.

12. A method as claimed in claim 8 further including the use of one or more predetermined hedging systems for managing any applicable payout by an index-linked structured product and any returns generated by the EFM portfolio such that an output is generated indicative of a value of EFMs required at any given time to satisfy a predetermined hedging objective to originate the dollar value of EFMs that match at any time for choosing the ratio of the index linked-structured product to EFM assets (Δ) to maximize any said payouts, said method comprising the steps of:
defining an index linked structured product with returns ag+b, where g is the index return;
for the value of the EFMs issued defining said EFM value times the ratio of the index linked-structured product to EFM assets ($Δ) of a structured product;
either: (i) investing $Δ paid by investors in said index-linked structured product at an interest rate r₀; or (ii) if the index-linked structured product is leveraged with a gearing G, investing $(1−G)Δ at the rate r₀ and receiving from the structured product customers an interest rate of r₁ and defining the interest income return to the index-linked structured product as r=(1−G) r₀+Gr₁;
defining r_{f} as the cost of capital to lend out as EFMs; and
weighting said EFM portfolio in each region in proportion to the total index-linked structured product portfolio wherein n EFMs with LVRs l₁, . . . , lₙ originated over collateral assets with initial values A₁⁰, . . . , Aₙ⁰;
generating a vector of returns dA for each property in the EFM portfolio and a larger vector of returns dP for the entire market spanning the index-linked structured product for a given future value of each property having an EFM originated thereon;
wherein for each path and for A in a range given a predetermined set of property market parameters and a payoff per dollar invested in the EFM portfolio with a minimum required EFM return over a time horizon T generating a market index return g from the vector dA of individual property returns based on the regional weightings in the market index;
calculating a structured product fund income I_{T}
selecting a value of Δ which maximizes at least one predetermined functional of the total income per dollar invested on the hedged EFM portfolio.

13. A method as claimed in claim 12 such that for predetermined mark-to-market value of the liabilities owing under one or more re-valued index-linked structured products wherein total liabilities determined by the return structure of the structured product and minimization of the dollar value of EFMs held to meet structured product obligations, said method comprising the step of dynamically determining on a predetermined basis an optimal dollar value of EFMs to meet said mark-to-market obligations such that more dollar value EFMs than funds raised by said index-linked structured products cannot be originated.

14. A method as claimed in claim 13 further including the step of defining an asset-selection rule for EFMs such that said EFMs have expected holding periods that most closely match the duration of the index-linked structured products that have been originated.

15. A method as claimed in claim 13 further including the step of automatically providing EFM borrowers with a financial incentive to repay any outstanding amounts more quickly if index-linked structured product redemptions are higher than predetermined expectations.

16. A method as claimed in claim 13 wherein funds equivalent to, or less than, the dollar value of EFMs raised by said index-linked structured products can be originated, the method further including the step of selecting EFMs that maximize excess returns that can be generated by EFMs over and above liabilities owing under the index-linked structured products as determined on a mark to market basis at every time such that predetermined EFMs based on one or more predetermined variables having the highest probability of meeting liabilities owing under the index-linked structured products and producing excess returns over and above these.

17. A method as claimed in claim 16 wherein for an existing portfolio of EFMs, which may or may not deviate in weighting from the model portfolio such that the current value of the EFM portfolio is E(t) where a given value of structured product issued with a ratio Δₜ, to the value EFM portfolio defining the current value E(t) as the sum over the values over each region;
defining origination times and values of the EFM properties and defining a set of property market parameters plus a regional correlation matrix and generating a vector of returns dA for each property in the EFM portfolio and a larger vector of returns dP of the entire market spanning the index-linked structured product each over the same time horizon T;
determining a future value of each EFM property and the future EFM portfolio value such that for all properties in the market P₁, . . . , P_{N} making up said index-linked structured product over a predetermined remaining period is determined;
determining the return on the entire position (H) over the remaining time period at a current level of issued EFM and index-linked structured product;
issuing a predetermined value of index-linked structured product but not exceeding a value of the EFMs and defining a hedge ratio of value of index-linked structured product to EFM where Δ>Δₜ and re-determining the return on the entire position (H*) over the remaining time period;
issuing additional predetermined EFMs over properties with predetermined values at time t. such that over the remaining period these values then change to provide the current EFM portfolio value E* at a current and the future EFM portfolio value after the remaining time elapses.

18. A method as claimed in claim 17 further including the steps of:
determining a new hedge ratio of value of index-linked structured product to EFM;
re-determining the return on the entire position (H*) over the remaining time period;
determining the value of Δ which maximizes a pre-determined function; and
for Δ>Δₜ, more index-linked structured product is issued and for Δ≦Δₜ, more EFMs are originated

19. A method as claimed in claim 18 further including the steps of determining a range of Δ so that said predetermined maximized function is within predetermined acceptable limits.

20. A method as claimed in claim 18 further including the step of determining a value of Δ which optimizes said predetermined maximized function by issuing additional structured product.
